(19) United States
(12) Patent Application Publication
(10) Pub. No.: US 2004/0258972 A1
(43) Pub. Date: Dec. 23, 2004

(54) Solid state electrochemical devices

(76) Inventors: Yanhai Du, Storrs, CT (US); Nigel Mark Sammes, Lincoln, RI (US); Raymond Oliver England, Harrisville, RI (US)

Correspondence Address: CANTOR COLBURN LLP, 55 Griffin Road South, Bloomfield, CT, 06002, US

(21) Appl. No.: 10/820,167

(22) Filed: Apr. 6, 2004

Related U.S. Application Data
(60) Provisional application No. 60/461,580, filed on Apr. 8, 2003.

(51) Int. Cl. H01M 8/24; H01M 8/10; H01M 4/92; H01M 8/12

(52) U.S. Cl. 429/31; 429/44; 429/45; 429/33

(57) ABSTRACT

In one embodiment, an electrochemical cell stack comprises at least two electrochemical cells, wherein each electrochemical cell comprises a hollow elongated electrolyte, having disposed upon it an anode and a cathode, and further wherein with the exception of the outermost cell, each electrochemical cell is placed within another electrochemical cell in a manner such that at least one of the surfaces of the respective electrochemical cells are approximately parallel to one another.

### CROSS REFERENCE TO RELATED APPLICATIONS

This application claims the benefit of U.S. Provisional Application Ser. No. 60/461,580, filed Apr. 10, 2003.

### BACKGROUND

The present disclosure is related to solid state electrochemical devices.

Solid state electrochemical devices such as fuel cells, oxygen pumps, sensors, and the like, generally offer opportunities for an efficient conversion of chemical energy to electric power with minimal pollution. Solid state electrochemical devices generally comprise an electrochemical cell, which is available in planar and tubular monolithic designs. Both of these types of electrochemical cell designs suffer from several drawbacks, foremost amongst which is that these cells are generally incapable of generating a voltage greater than about 1 volt. Tubular designs have the additional drawback of low volumetric power packing density. In other words, in order to generate an equivalent amount of power, a tubular electrochemical cell is generally much larger in size than a planar electrochemical cell. One of the drawbacks of increasing the size (i.e., either the diameter or length) of an electrochemical cell to generate larger amounts of power is lower fuel utilization. There is therefore a need for improving the power and voltage performance as well as the fuel utilization of an electrochemical cell, so as to improve the performance of solid state electrochemical devices, without increasing the outer dimensions of the device.

### BRIEF SUMMARY

In one embodiment, an electrochemical cell stack comprises at least two electrochemical cells, wherein each electrochemical cell comprises a hollow elongated electrolyte, having disposed upon it an anode and a cathode, and further wherein with the exception of the outermost cell, each electrochemical cell is placed within another electrochemical cell in a manner such that at least one of the surfaces of the respective electrochemical cells are approximately parallel to one another.

### FIGURES

FIG. 1 is a schematic representing one possible configuration of an electrochemical cell stack;

FIG. 2 is a schematic showing one possible arrangement of an electrochemical cell stack on a base plate;

FIG. 3 is a graphical representation of i) the power generated when the number of electrochemical cells in a concentric stack is increased from 1 to 3 to 5 as well as ii) the volumetric power packing density when the diameter of a single electrochemical cell is reduced; and

FIG. 4 is a graphical representation contrasting the volumetric power packing density for a single cell versus a stack having either three or five cells as the cell diameter is varied.

### DETAILED DESCRIPTION OF PREFERRED EMBODIMENTS

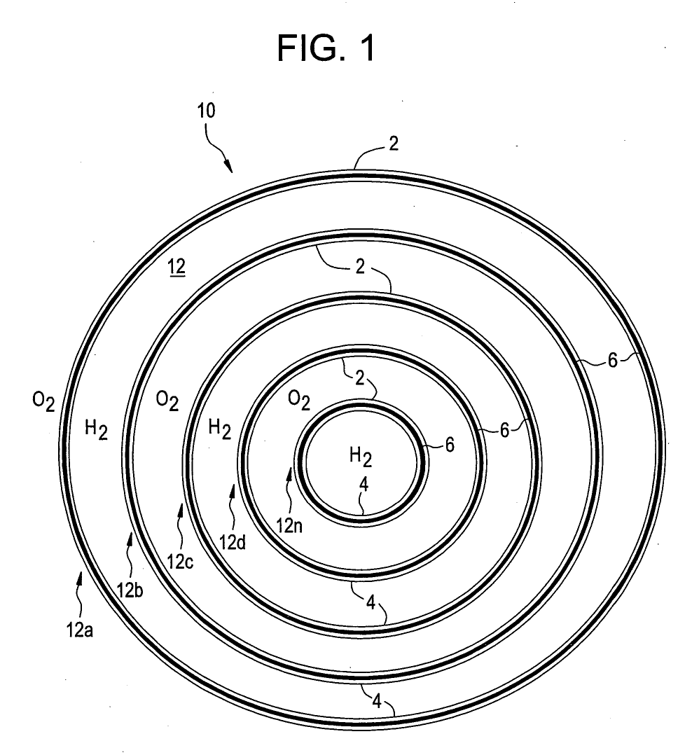

Disclosed herein, as detailed in the FIG. 1, is an electrochemical cell stack 10 wherein the respective electrochemical cells 12a, 12b, 12c, 12d, . . . 12n are arranged so that at least one of their surfaces is parallel to one another. While it is generally desirable for the respective electrochemical cells to be arranged concentrically within the stack (i.e., where the longitudinal axis of all cells 12a, 12b, . . . 12n are superimposed upon one another), it may also be desirable to have them arranged eccentrically, (i.e., where the longitudinal axis of all cells 12a, 12b, . . . 12n are not superimposed upon one another). As may be seen in FIG. 1, the cells are arranged in a manner such that either the anodes 4 or the cathodes 2 for any given adjacent pair of electrochemical cells in the stack 10 are radially opposed to each other. In other words, any two successive electrochemical cells (e.g., 12a and 12b) have at least one pair of anodes 4 or cathodes 2 circumferentially opposed to each other. Similarly, for any three successive electrochemical cells (e.g., 12a, 12b and 12c), there is at least one pair of anodes 4 circumferentially opposed to each other and at least one pair of cathodes 2 radially opposed to each other. The term “circumferentially opposed” as defined herein refers to a pair of active (i.e., they are in direct contact with the oxygen and hydrogen) surfaces of either the anode or the cathode that face each other. This method of concentrically arranging the electrochemical cells into a stack 10 is advantageous in that the size of the stack 10 is significantly smaller than other stacked designs that employ electrochemical cells. This design increases the volumetric packing power density (Pᵥ) by at least about 84% for a 2 tube assembly and at least about 116% for a 5 tube assembly and may be advantageously utilized as a fuel cell for the generation of power, a sensor for the detection of impurities, an oxygen pump for generating oxygen and a number of other commercial applications.

As may be seen in FIG. 1, each electrochemical cell 12a, 12b, . . . 12n in the stack 10 comprises a hollow elongated electrolyte 6 coated with an anode 4 and a cathode 2. Optionally, if desired, an interlayer may be placed between the hollow elongated electrolyte 6 and the anode 4 to prevent the formation of a resistive layer as a result of the reaction between elements of the anode 4 and the electrolyte 6 during the process of sintering. Either the hollow elongated electrolyte 6, the anode 4 or the cathode 2 or any combination of the foregoing may be used as the supporting structure for the individual electrochemical cells. While the hollow elongated electrolyte 6 and hence the respective electrochemical cells 12a, 12b, . . . 12n, as defined herein, may in general have a variety of different geometries, they have at least one surface that closes upon itself. A suitable example of hollow elongated structure, having at least one surface that closes upon itself, is a tube. As may be seen in FIG. 1, each electrochemical cell (e.g., 12a) in the stack 10 is separated from the adjacent cell (e.g., 12b) in the stack 10 by a uniform distance. While a uniform distance between the successive electrochemical cells 12a, 12b, . . . 12n is generally desired, it may also be possible to arrange successive cells 12a, 12b, . . . 12n to be non-equidistantly spaced from each other. This distance between the respective cells 12a, 12b, . . . 12n is used to feed reactants such as the air, oxygen, or the like, to the cathode 2 and the hydrogen, or the like, to the anode 4, of each electrochemical cell forming the stack.

In one embodiment, the hollow elongated electrolyte 6 may be formed from solid oxide ceramic powders such as sintered yttria stabilized zirconia (YSZ), lanthanum strontium gallium magnesium oxide (LSGM), or the like, solid proton-conducting polymer membranes such as perfluorosulfonic acid materials, sulfonated or nitrated polybenzimidazoles and polyether ether ketone, or the like, phosphoric acid held in a silicon carbide matrix, molten carbonate, or the like, or combinations comprising at least one of the foregoing electrolytic materials.

Solid oxide ceramic powders used to form the hollow elongated electrolyte 6 are generally desired to be stable at voltages greater than or equal to about 0.1 Volts (V) and/or elevated temperatures greater than or equal to about 600° C. Since it is generally desirable to minimize electronic conductivity and promote ionic conductivity in a solid oxide electrochemical device, the metal ions in the electrolyte should have at least one thermodynamically stable valence state in order to minimize electron transfer due to the reduction of the metal ions. Zirconia, hafnia and thoria display such stability and may therefore be preferably utilized in the hollow elongated electrolyte 6. Doping agents, which increase ionic conductivity over electronic conductivity, may be added to the zirconia, hafnia, thoria, or the like, or combinations comprising at least one of the foregoing metal oxides. Suitable examples of such doping agents are yttria, yterbia, or the like, or combinations comprising at least one of the foregoing doping agents. A preferred solid oxide ceramic powder for use in a hollow elongated electrolyte 6 is yttria stabilized zirconia (YSZ).

In another embodiment, the hollow elongated electrolyte 6 may be manufactured from a solid oxide ceramic powder comprising lanthanum strontium gallium magnesium oxide (LSGM) as expressed as in the formula (I) below:

La₁₋ₐAₐGa_{1-b}B_{b}O_{3-c} (I)

wherein La represents lanthanum, A is strontium or calcium, Ga is gallium, B is magnesium, aluminum or indium and O is oxygen and wherein 0.05≦a≦0.3, 0≦b≦0.3, c=(a+b)/2 (0≦c≦0.15, b+c≦0.3 and 0≦d≦1). In yet another embodiment, the LSGM has three or more crystal phases each having a different composition. The language “crystal phases having a different composition” as used herein is intended to mean crystal phases containing the same or different kinds of constituent elements but wherein the molar ratio of the different elements contained in the different crystal phases is different. For example, when one crystal phase contains lanthanum, gallium and three other elements in a molar ratio of a:b:c:d:e, the molar ratio of the same elements in another crystal phase may be a:b′:c′:d′:e, a′:b′:c′:d′:e′, and the like, provided that a≠a′, b≠b′, c≠c′, d≠d′, and e≠e′.

It is generally desirable for the hollow elongated electrolyte 6 derived from an LSGM to have a first crystal phase close to the stoichiometric ratio of LaGaO₃ (i.e., La:Ga:O=1:1:3), and a second crystal phase whose composition is different from the stoichiometric ratio of the elements contained in the first crystal phase. It is also generally desirable for the hollow elongated electrolyte 6 to have a third crystal phase, which is different in composition from either the first or the second crystal phase. This additional crystal phase is usually a grain boundary phase and is hereinafter referred to as the third crystal phase.

The hollow elongated electrolyte 6 having the above-described structure (i.e., three different crystal phases) is generally formed by incorporation of aluminum. In order to have the three different crystal phases it is generally desirable to have the molar ratio of aluminum to the sum of lanthanum, gallium and oxygen from about 0.05 to about 0.5. Within this range it is desirable to have the molar ratio less than or equal to about 0.2, preferably less than or equal to about 0.1. The preferred LSGM is La_{0.8}Sr_{0.2}Ga_{0.8}Mg_{0.2}O_{2.8}.

Solid proton-conducting polymer membranes, which may be used to form the hollow elongated electrolyte 6, are generally manufactured from polymers having substantially fluorinated carbon backbones and optionally having attached to this backbone side chains that are substantially fluorinated. These polymers generally contain sulfonic acid groups or derivatives of sulfonic acid groups, carboxylic acid groups or derivatives of carboxylic acid groups, phosphonic acid groups or derivatives of phosphonic acid groups, phosphoric acid groups or derivatives of phosphoric acid groups and/or combinations comprising at least one of these groups. Perfluorinated polymers include NAFION® commercially available from E. I. Dupont de Nemours, ACIPLEX® commercially available from Asahi Chemical Industries, and FLEMION® commercially available from Asahi Glass K K respectively. Other sulfonated fluoropolymers, which may be used as the hollow elongated electrolyte 6 include those disclosed in U.S. Pat. No. 5,595,676 to Barnes et al. and U.S. Pat. No. 4,940,525 to Ezell et al., both of which are hereby incorporated by reference.

Other perfluorinated or partially fluorinated polymers which may be used to form the hollow elongated electrolyte 6 are those containing aromatic rings such as those described in WO 95/08581 to Wei et al. and WO 97/25369 to Steck et al., both of which are hereby incorporated by reference and which have been functionalized with SO₃H, PO₂H₂, PO₃H₂, CH₂PO₃H₂, COOH, OSO₃H, OPO₂H₂, OPO₃H₂ radicals. Also included are radiation or chemically grafted perfluorinated polymers, in which a perfluorinated carbon backbone, such as, for example, polytetrafluoroethylene (PTFE), fluorinated ethylene-propylene (FEP), tetrafluoroethylene-ethylene (ETFE) copolymers, tetrafluoroethylene-perfluoroalkoxy (PFA) copolymers, poly (vinyl fluoride) (PVF) and/or poly (vinylidene fluoride) (PVDF) is activated by radiation or chemical initiation in the presence of a monomer, such as styrene, which can then be functionalized to contain an ion exchange group.

Fluorinated polymers such as those disclosed in EP 0 331 321 to Fielding et al. and EP 0345 964 to Marshall et al., both of which are hereby incorporated by reference, and which contain a polymeric backbone with pendant saturated cyclic groups and at least one ion exchange group that is linked to the polymeric backbone through the cyclic group may also be used to form the hollow elongated electrolyte 6.

Aromatic polymers, which may be used to form the hollow elongated electrolyte 6 are those disclosed in EP 0 574 791 and U.S. Pat. No. 5,438,082 to Helmer-Metzmann et al. such as, for example, sulfonated polyaryletherketone. Nonfluorinated polymers that may be used as electrolytes include those disclosed in U.S. Pat. No. 5,468,574 to Ehrenberg et al., which is hereby incorporated by reference, such as, for example, styrene- (ethylene-butylene)-styrene, styrene-(ethylene-propylene)-styrene, acrylonitrile-butadiene-styrene copolymer and acrylonitrile-butadiene-styrene terpolymers, wherein the styrene components are functionalized with sulphonate, phosphoric and/or phosphonic groups. Nitrogen containing polymers such as polybenzimidazole alkyl sulfonic acid and polybenzimidazole alkyl or aryl phosphonate disclosed in U.S. Pat. No. 5,599,639 to Sansone et al., which is hereby incorporated by reference, may also be used to form the hollow elongated electrolyte 6.

The hollow elongated electrolyte 6 derived from solid oxide ceramic powders, solid proton-conducting polymer membranes, phosphoric acid held in a silicon carbide matrix, or the like, may be formed into a desired geometry in a single screw extruder, twin-screw extruder, buss kneader, ram extruder or combinations comprising the foregoing extruders. Alternatively, the hollow elongated electrolyte 6 may be injection molded, compression molded, blow molded, vacuum formed in order to obtain the hollow elongated electrolyte 6. The extruded or molded hollow elongated electrolyte 6 is generally dried and sintered prior to utilization in an electrochemical cell.

The edges of the hollow elongated electrolyte 6, and hence those of the electrochemical cells 12a, 12b, . . . 12n, may possess any chosen geometry such as, but not limited to, triangular, square, rectangular, hexagon, pentagon, decagon, elliptical, circular, rhombohedral, or the like, or combinations comprising at least one of the foregoing geometries so long as at least one surface of the hollow elongated electrolyte 6 closes upon itself. It may also be desirable to have successive electrochemical cells 12a, 12b, . . . 12n in the stack having different geometries. For example, the outermost electrochemical cell may have an edge which is circular in shape, while the electrochemical cell adjacent to the outermost cell may have a square edge. The preferred geometry of the edge of the hollow elongated electrolyte 6 is circular so that the hollow elongated electrolyte 6 as well as the resulting electrochemical cell is tubular in shape.

In one embodiment, the aspect ratio of the hollow elongated electrolyte 6 is greater than or equal to about 1. The aspect ratio of an electrochemical cell as defined herein, is the largest dimension measured vertically between the open edges of the hollow elongated electrolyte 6 divided by the largest dimension of the inner surface of the hollow elongated electrolyte 6 measured horizontally. It is generally preferred to have the aspect ratio greater than or equal to about 5, preferably greater than or equal to about 7, and more preferably greater than or equal to about 10.

Electrochemical cells generally employ hollow elongated electrolytes having a wall thickness of about 5 to about 2000 micrometers. Within this range, it is generally desired to have a wall thickness value of greater than or equal to about 6 micrometers, preferably greater than or equal to about 7 micrometers, and more preferably greater than or equal to about 8 micrometers. Similarly, within this range, it is generally desired to have a wall thickness of less than or equal to about 1500 micrometers, preferably less than or equal to about 1200 micrometers, and more preferably less than or equal to about 1000 micrometers. The preferred wall thickness is about 10 to about 1000 micrometers.

The hollow elongated electrolyte 6 may then be utilized to form a single electrochemical cell 12a, 12b, . . . 12n by applying an anode 4, cathode 2 and the associated current collectors to the hollow elongated electrolyte 6. The materials used for the anode 4, the cathode 2, and the electrolyte 6 may vary depending upon the application for which the electrochemical cell is utilized. For example, electrochemical cells used as fuel cells for power generation in industrial applications and distributed power generators at elevated temperatures greater than or equal to about 600° C., generally use hollow elongated electrolytes 6 manufactured from YSZ, LSGM, gadolinium doped ceria (GDC) samarium doped ceria (SDC), scandium doped zirconia (ScZ), or the like, or combinations comprising at least one of the foregoing electrolytes 6. Similarly, anodes 4 utilized at temperatures greater than or equal to about 600° C. are manufactured from nickel oxide (NiO), cobalt (Co) or cobalt oxide (CoO or Co₃O₄), nickel zirconia, nickel oxide with yttrium stabilized zirconia (Ni+8YSZ), nickel oxide with samarium doped ceria (SDC20+Ni), nickel with YSZ, gadolinium doped ceria (GDC) or combinations comprising at least one of the foregoing ceramic powders. Cathodes 2 utilized at temperatures greater than or equal to about 600° C. are generally manufactured from lanthanum-samarium-cobalt (LSCo), lanthanum-samarium-cobalt ferrite (LSCF), samarium-strontium-cobalt (SmSrCo), samarium-strontium-cobalt oxide (SmSrCoO₃), strontium doped lanthanum manganite (LSM), lanthanum manganite, or combinations comprising at least one of the foregoing ceramic powders.

For applications where the electrochemical cell is utilized at temperatures lower than 600° C. such as in applications for power generation in automobiles, buildings, and the like, the hollow elongated electrolyte 6 may be manufactured from a silicon carbide matrix that holds phosphoric acid, proton conducting polymer membrane, molten carbonate salt, alkaline electrolyte such as, for example, potassium hydroxide, or the like or combinations comprising at least one of the foregoing electrolytes. Similarly, the anodes 4 in an electrochemical cell utilized at temperatures lower than or equal to about 600° C. are generally metallic catalysts manufactured from platinum, ruthenium, iridium, rhodium, palladium, molybdenum, or combinations comprising at least one of the foregoing catalysts disposed upon carbon paper or carbon fibers. Cathodes 2, utilized at temperatures lower than or equal to about 600° C. are generally manufactured from some of the same metal catalysts used in the anodes and are generally disposed upon carbon black.

The anode 4, cathode 2, and optionally an interlayer may generally be applied to the hollow elongated electrolyte 6 by a number of different methods such as, but not limited to, dip coating, dip coating using a syringe-pipe configuration, chemical vapor deposition, spray painting, electrostatic painting, painting with a brush, or the like, or combinations of at least one of the foregoing methods. The preferred methods of applying the anode, the interlayer, and the cathode to a solid oxide hollow elongated electrolyte 6 is by dip coating using a syringe-pipe configuration or painting with a brush. In those cases where proton-conducting polymer membranes are used to form the hollow elongated electrolyte 6, the anode 4 and the cathode 2 are preferably applied by chemical vapor deposition. The anode 4 and the cathode 2 are generally applied to the hollow elongated electrolyte 6 in such a manner that if the anode 4 is applied to the inner surface, the cathode 2 is applied to the outer surface and vice-versa.

It is generally desirable to have at least two electrochemical cells arranged concentrically to form the stack. While there is generally no limit to the number of electrochemical cells in the stack 10, it is generally desirable to have about 2 to about 7 electrochemical cells in a given stack. The electrochemical cells in the stack 10 may have any desirable active length. The active length as defined herein is the vertical length measured between the open edges of a single electrochemical cell in the stack 10. In general the active length may be about 2 millimeters to about 20,000 millimeters and. Within this range it is generally desirable to have the active length be greater than or equal to about 10, preferably greater than or equal to about 20, and more preferably greater than or equal to about 50 millimeters. Also desirable is an active length less than or equal to about 10,000, preferably less than or equal to about 5000, and more preferably less than or equal to about 2,000 millimeters. The preferred length is about 100 millimeters to about 500 millimeters. The smallest horizontal dimension measured between the inner surfaces of the smallest electrochemical cell in the stack is about 2 millimeters to about 50 millimeters. The preferred smallest horizontal dimension of the smallest electrochemical cell in the stack is about 3 millimeters to about 20 millimeters.

After the formation of the anode 4, cathode 2 and the optional interlayer, the respective current collectors may be applied to the electrodes to form an electrochemical cell. For example, a silver wire cathode current collector is tightly wound onto the outside of the electrochemical cell after the cathode 2 applied. Similarly, a nickel mesh may be applied to the anode 4 as the anode current collector. The current collectors to the respective electrochemical cells in the stack may be in electrical communication in series or in parallel to a resistive load in the case of a fuel cell or to a data analyzer in the case of a sensor to complete the electrochemical cell stack 10.

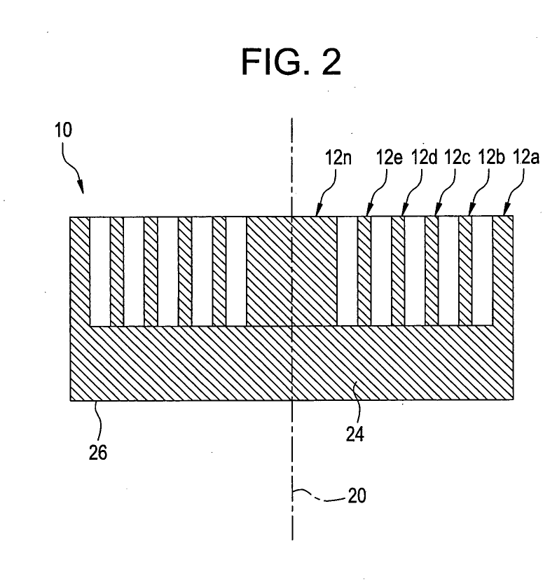

A number of electrochemical cells 12a, 12b, . . . 12n may then be used to form the electrochemical cell stack 10 by arranging electrochemical cells in a concentric or in an eccentric fashion as desired. FIG. 1 reflects one particular arrangement wherein the electrochemical cells are arranged concentrically. In one embodiment, the concentric spacing and stacking of the respective single electrochemical cells is achieved by the use of a base plate having concentric grooves, wherein the successive grooves have the same dimensions as the average dimensions of the successive electrochemical cells. In another embodiment, the electrochemical cells are disposed in a manner such that the longitudinal axis of the electrochemical cells is perpendicular to a surface of the base plate. As shown in FIG. 2, the respective electrochemical cells 12a, 12b, . . . 12n are disposed on the base plate such that the longitudinal axis 20 of the stack 10 is vertical with respect to the base 26 of the base plate 24. The successive grooves may be uniformly spaced from one another in order to arrange the electrochemical cells 12a, 12b, . . . 12n in a concentric fashion. They may be non-uniformly spaced in order to arrange the cells in an eccentric fashion. The thickness of a particular groove within the base plate may be greater than, less than, or equal to the wall thickness of the electrochemical cell that fits into that particular groove. In general it is desirable for a single electrochemical cell to fit into each groove. The electrochemical cells 12a, 12b, . . . 12n are generally placed in the grooves and may be affixed to the base plate by devices such as, but not limited to, nuts, bolts, screws, bolts, rivets, adhesive, or the like, or combinations comprising at least one of the foregoing means of attachment.

A preferred means of attachment of the individual electrochemical cells to the base plate is by using a tight fit, wherein the base plate is heated prior to the insertion of the electrochemical cell into the groove. The heating of the base plate permits the groove to expand slightly to allow the electrochemical cell to fit into the groove. Following the insertion of the electrochemical cell into the groove, the base plate is cooled down to effect a tight fit between the base plate and the electrochemical cell. The base plate may have at least two grooves and may generally have a thickness of greater than or equal to about 2 millimeters. The base plate may preferably have a thickness greater than or equal to about 5, more preferably greater than or equal to about 7, and most preferably greater than or equal to about 10 millimeters if desired.

The base plate 24 is generally derived from materials such as, but not limited to, metals such as nickel or nickel based alloys, metals such as nickel or nickel based alloys coated with the YSZ or LSGM, glass, ceramics, high temperature polymers such as polyimides, polybenzimidazoles, liquid crystalline polymers, ceramics containing reinforcement such as glass fibers, metal fibers and particles, polymeric fibers, derived from high temperature polymers or the like, or combinations comprising at least one of the foregoing high temperature materials. The preferred materials for the base plate are nickel or nickel based alloys.

In another embodiment, the respective electrochemical cells 12a, 12b, . . . 12n may be disposed concentrically by connecting successive electrochemical cells to each other using spacers having a uniform length so that the distance between successive electrochemical cells of the stack is uniform. If an eccentric design is desired then the spacers need not all be of the length. It is generally desirable that the spacer be capable of withstanding the temperature of operation of the electrochemical cell stack 10. The spacer may be connected to successive electrochemical cells cells 12a, 12b, . . . 12n by means of fasteners that are capable of withstanding the temperatures of operation of the electrochemical cell stack 10. Spacers and fasteners may be derived form materials such as, but not limited to metals such as nickel or nickel based alloys, nickel and nickel based alloys coated with ceramics such as YSZ and LSGM, glass, ceramics, high temperature polymers such as polyimides, polybenzimidazoles, liquid crystalline polymers, crosslinked polymers, ceramics containing reinforcement such as ceramic fibers and whiskers, glass fibers, metal fibers and particles, polymeric fibers derived from high temperature polymers or the like, or combinations comprising at least one of the foregoing high temperature materials. The preferred spacer materials are nickel and/or nickel based alloys.

In general, the base plate or the spacer separate the successive concentric or eccentric electrochemical cells by a distance of about 0.5 millimeter to about 20 millimeters. Within this range, a distance of greater than or equal to about 1 millimeter, preferably greater than or equal to about 1.5 millimeter, and more preferably greater than or equal to about 1.8 millimeter is preferred. Similarly, it is generally desirable to maintain the distance between two successive concentric or eccentric electrochemical cells at less than or equal to about 20 millimeter, preferably less than or equal to about 15 millimeter, and more preferably less than or equal to about 10 millimeters.

In one embodiment, in one method of operation of the electrochemical cell stack 10, the electrochemical cells 12a, 12b, . . . 12n affixed to the base plate are in electrical communication with a resistive load and function as a fuel cell. The base plate generally serves as a manifold for the oxygen, which is fed to the cathode 2, and the hydrogen, which is fed to the anodes 4. The passage of the respective gases in the channels of the concentrically arranged electrochemical cell stacks is shown in FIG. 1. The air passes between the cathodes 2 while the hydrogen passes between the anodes 4. The gases are converted between the electrodes of the fuel cell thereby producing electricity. The electricity is passed to one end of the cells through electrically conducting wires or inks in the electrodes. The individual electrochemical cells are generally in electrical communication in series at the bottom of the base plate. The fuel gas entering into the electrochemical cells is generally converted to electricity in an amount of about 50 to about 90%.

In another embodiment, the electrochemical cell stack 10 may be operated as a gas sensor. In this mode of operation, the potential developed between the anode 4 and the cathode 2 is dependent upon the ratio of the concentrations of identical chemical particles such as, for example, oxygen gas, or the like, at each electrode. The chemical reactions taking place at each electrode are identical but are the reverse of one another; i.e., at one electrode the reduced form of the chemical particle is being oxidized (releasing electrons) and at the other electrode the oxidized form is being reduced (accepting electrons). The potential developed as a result of the extent of these respective reactions at each electrode is then fed to a data analyzer and is utilized to express the concentration of the gas being detected. The electrochemical cell stack 10 may also find use in other applications such as oxygen pumps, chemical sensors, and the like.

The electrochemical cell stack 10 described above has a number of advantageous features. For example, by increasing the number of electrochemical cells in a given stack the power packing density can be increased without any increase in the size (overall dimensions) of the stack 10. Thus by increasing the number of electrochemical cells in a stack from 1 to 2, the power packing density increases by about 84%, while increasing the number of electrochemical cells from 1 to 5 would cause an increase of about 116% in the power packing density. Similarly, a decrease in the spacing between successive electrochemical cells in the stack from 4 millimeters to 2 millimeters will cause an increase of about 30 to about 40% power generated for a stack of the same size. This method of stacking also increases the fuel utilization rate since the fuel is consumed rapidly by the presence of two similar reactive electrode surfaces bounding any channel within the stack through which the gas passes. The presence of two reactive surfaces increases the reaction probability.

The following examples, which are meant to be exemplary, not limiting, illustrate compositions and methods of manufacturing some of the various embodiments of the electrochemical cell and the devices derived therefrom.

### EXAMPLES

### Example 1

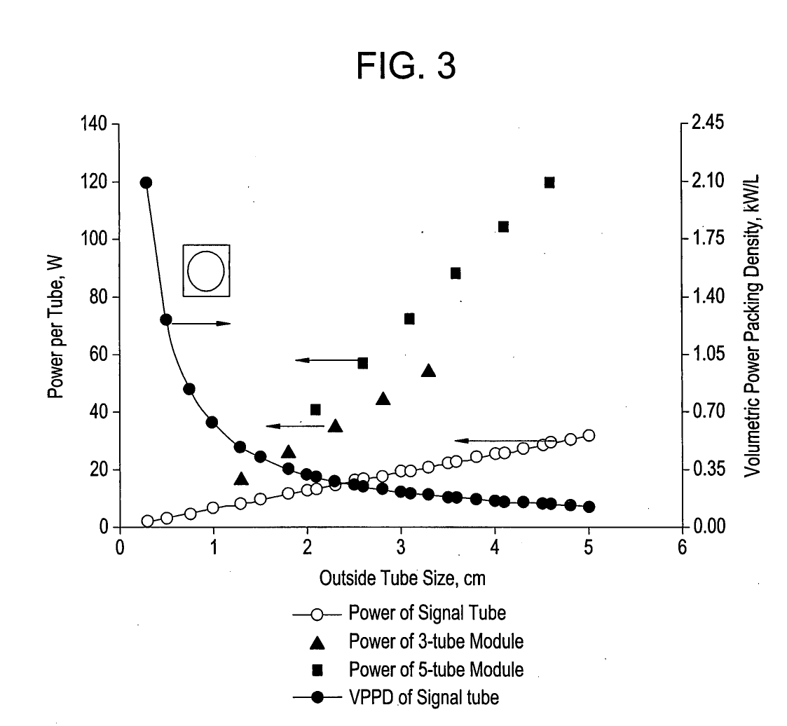

In this paper example, the power as well as the volumetric power packing density for a stack having tubular electrochemical cells was studied as a function of the outer diameter of a tubular electrochemical cell. FIG. 3 is a graphical representation of the power as well as the volumetric power packing density (for a stack having tubular electrochemical cells) plotted versus the inner tube diameter. The electrochemical cells were arranged concentrically and the number of cells was increased from 1 to 3 to 5. The active length of the tube was 10 centimeters and the power density was 0.2 watts/square centimeter (W/cm²). The power generated as well as the volumetric power packing density for the electrochemical cells having 1, 3 and 5 cells respectively are shown in Tables 1, 2 and 3 respectively. The variation in the distance between successive tubes for the electrochemical cells having 3 and 5 electrochemical cells respectively are shown in Tables 2 and 3.

The results from tables 1, 2 and 3 are plotted in FIG. 3. From FIG. 3, it may be seen that the power generated by the stack increases with the increase in outer diameter as well as the number of cells in the stack. The power generated increases from approximately 30 watts for a single tube electrochemical cell to about 120 watts for a stack containing 5 concentric electrochemical cells, when the outer diameter is 5 centimeters. Without being limited by theory, it may generally be inferred that as the number of electrochemical cells in the concentric stack is increased, the larger surface area available for reactions promotes an increase in the power generated.

An examination of the volumetric power packing density (Pᵥ) in the FIG. 3 also shows that a decrease in the diameter of the tube promotes an increase in Pᵥ. It may be seen that for a tube having an outer diameter of about 0.25 centimeters, the volumetric power packing density is approximately 2.1. This is very difficult to achieve from a practical engineering standpoint because of the small diameter involved. One possible way of achieving a high volumetric power packing density is by stacking the electrochemical cells as shown in Example 2.

TABLE 1

| Number of tubes | d₁, cm ID of the smallest tube | Δd, cm ID difference | dₙ, cm ID of tube dₙ, the largest tube d1 + (n − 1)Δd | A, cm²Total active area πnL(d1 + (n − 1)πd/2) | P, W Total power P = A * Pₐ | V₀, cm^{3 Equal square box volume d}ₙ²L | V, cm³Volume of the cells occupied 3.14L(dₙ | | |
|---|---|---|---|---|---|---|---|---|---|
| #/2)² | $\begin{matrix}{P}_{v} , W \text{/} mL \\ \begin{matrix}Volumetric \\ power density \\ {P}_{v} = \frac{4 {P}_{a} n ( {d}_{1} + \frac{n - 1}{2} Δd )}{{[ {d}_{1} + ( n - 1 ) Δd ]}^{2}}\end{matrix}\end{matrix}$ | P_{sq}, W/ml VPD for square box Pₐ · A/V₀ | | | | | | | |
| 1.00 | 0.30 | 0.00 | 0.30 | 9.42 | 1.88 | 0.90 | 0.71 | 2.67 | 2.09 |
| 1.00 | 0.50 | 0.00 | 0.50 | 15.71 | 3.14 | 2.50 | 1.96 | 1.60 | 1.26 |
| 1.00 | 0.75 | 0.00 | 0.75 | 23.56 | 4.71 | 5.63 | 4.42 | 1.07 | 0.84 |
| 1.00 | 1.00 | 0.00 | 1.00 | 31.42 | 6.28 | 10.00 | 7.85 | 0.80 | 0.63 |
| 1.00 | 1.50 | 0.00 | 1.50 | 47.12 | 9.42 | 22.50 | 17.66 | 0.53 | 0.42 |
| 1.00 | 2.00 | 0.00 | 2.00 | 62.83 | 12.57 | 40.00 | 31.40 | 0.40 | 0.31 |
| 1.00 | 2.50 | 0.00 | 2.50 | 78.54 | 15.71 | 62.50 | 49.06 | 0.32 | 0.25 |
| 1.00 | 3.00 | 0.00 | 3.00 | 94.25 | 18.85 | 90.00 | 70.65 | 0.27 | 0.21 |
| 1.00 | 3.50 | 0.00 | 3.50 | 109.96 | 21.99 | 122.50 | 96.16 | 0.23 | 0.18 |
| 1.00 | 4.00 | 0.00 | 4.00 | 125.66 | 25.13 | 160.00 | 125.60 | 0.20 | 0.16 |
| 1.00 | 4.50 | 0.00 | 4.50 | 141.37 | 28.27 | 202.50 | 158.96 | 0.18 | 0.14 |
| 1.00 | 5.00 | 0.00 | 5.00 | 157.08 | 31.42 | 250.00 | 196.25 | 0.16 | 0.13 |

TABLE 2

| N Number of tubes | d₁, cm ID of the smallest tube | Δd, cm ID difference | dₙ, cm ID of tube dₙ, the largest tube d1 + (n − 1)Δd | A, cm²Total active area πnL(d1 + (n − 1)πd/2) | P, W Total power P = A * Pₐ | V₀, cm^{3 Equal square box volume d}ₙ²L | V, cm³Volume of the cells occupied 3.14L(dₙ | | |
|---|---|---|---|---|---|---|---|---|---|
| #/2)² | $\begin{matrix}{P}_{v} , W \text{/} mL \\ \begin{matrix}Volumetric \\ power density \\ {P}_{v} = \frac{4 {P}_{a} n ( {d}_{1} + \frac{n - 1}{2} Δd )}{{[ {d}_{1} + ( n - 1 ) Δd ]}^{2}}\end{matrix}\end{matrix}$ | P_{sq}, W/ml VPD for square box Pₐ · A/V₀ | | | | | | | |
| 3.00 | 1.00 | 0.10 | 1.20 | 103.67 | 20.73 | 14.40 | 11.30 | 1.83 | 1.44 |
| 3.00 | 1.00 | 0.20 | 1.40 | 113.10 | 22.62 | 19.60 | 15.39 | 1.47 | 1.15 |
| 3.00 | 1.00 | 0.30 | 1.60 | 122.52 | 24.50 | 25.60 | 20.10 | 1.22 | 0.96 |
| 3.00 | 1.00 | 0.40 | 1.80 | 131.95 | 26.39 | 32.40 | 25.43 | 1.04 | 0.81 |
| 3.00 | 1.00 | 0.50 | 2.00 | 141.37 | 28.27 | 40.00 | 31.40 | 0.90 | 0.71 |
| 3.00 | 1.00 | 0.60 | 2.20 | 150.80 | 30.16 | 48.40 | 37.99 | 0.79 | 0.62 |
| 3.00 | 0.30 | 0.40 | 1.10 | 65.97 | 13.19 | 12.10 | 9.50 | 1.39 | 1.09 |
| 3.00 | 0.50 | 0.40 | 1.30 | 84.82 | 16.96 | 16.90 | 13.27 | 1.28 | 1.00 |
| 3.00 | 1.00 | 0.40 | 1.80 | 131.95 | 26.39 | 32.40 | 25.43 | 1.04 | 0.81 |
| 3.00 | 1.50 | 0.40 | 2.30 | 179.07 | 35.81 | 52.90 | 41.53 | 0.86 | 0.68 |
| 3.00 | 2.00 | 0.40 | 2.80 | 26.19 | 45.24 | 78.40 | 61.54 | 0.73 | 0.58 |
| 3.00 | 2.50 | 0.40 | 2.30 | 73.32 | 54.66 | 108.90 | 85.49 | 0.64 | 0.50 |

TABLE 3

| N Number of tubes | d₁, cm ID of the smallest tube | Δd, cm ID difference | dₙ, cm ID of tube dₙ, the largest tube d1 + (n − 1)Δd | A, cm²Total active area πnL(d1 + (n − 1)πd/2) | P, W Total power P = A * Pₐ | V₀, cm^{3 Equal square box volume d}ₙ²L | V, cm³Volume of the cells occupied 3.14L(dₙ | | |
|---|---|---|---|---|---|---|---|---|---|
| #/2)² | $\begin{matrix}{P}_{v} , W \text{/} mL \\ \begin{matrix}Volumetric \\ power density \\ {P}_{v} = \frac{4 {P}_{a} n ( {d}_{1} + \frac{n - 1}{2} Δd )}{{[ {d}_{1} + ( n - 1 ) Δd ]}^{2}}\end{matrix}\end{matrix}$ | P_{sq}, W/ml VPD for square box Pₐ · A/V₀ | | | | | | | |
| 5.00 | 1.00 | 0.20 | 1.80 | 219.91 | 43.98 | 32.40 | 25.43 | 1.73 | 1.36 |
| 5.00 | 1.00 | 0.30 | 2.20 | 251.33 | 50.27 | 48.40 | 37.99 | 1.32 | 1.04 |
| 5.00 | 1.00 | 0.40 | 2.60 | 282.74 | 56.55 | 67.60 | 53.07 | 1.07 | 0.84 |
| 5.00 | 1.00 | 0.50 | 3.00 | 314.16 | 62.83 | 90.00 | 70.65 | 0.89 | 0.70 |
| 5.00 | 1.00 | 0.60 | 3.40 | 345.58 | 69.12 | 115.60 | 90.75 | 0.76 | 0.60 |
| 5.00 | 0.30 | 0.20 | 1.10 | 109.96 | 21.99 | 12.10 | 9.50 | 2.31 | 1.82 |
| 5.00 | 0.50 | 0.20 | 1.30 | 141.37 | 28.27 | 16.90 | 13.27 | 2.13 | 1.67 |
| 5.00 | 1.00 | 0.20 | 1.80 | 219.91 | 43.98 | 32.40 | 25.43 | 1.73 | 1.36 |
| 5.00 | 1.50 | 0.20 | 2.30 | 298.45 | 59.69 | 52.90 | 41.53 | 1.44 | 1.13 |
| 5.00 | 2.00 | 0.20 | 2.80 | 376.99 | 75.40 | 78.40 | 61.54 | 1.22 | 0.96 |
| 5.00 | 2.50 | 0.20 | 3.30 | 455.53 | 91.11 | 108.90 | 85.49 | 1.07 | 0.84 |
| 5.00 | 3.00 | 0.20 | 3.80 | 534.07 | 106.81 | 144.40 | 113.35 | 0.94 | 0.74 |
| 5.00 | 3.50 | 0.20 | 4.30 | 612.61 | 122.52 | 184.90 | 145.15 | 0.84 | 0.66 |
| 5.00 | 4.00 | 0.20 | 4.80 | 691.15 | 138.23 | 230.40 | 180.86 | 0.76 | 0.60 |
| 5.00 | 4.50 | 0.20 | 5.30 | 769.69 | 153.94 | 280.90 | 220.51 | 0.70 | 0.55 |
| 5.00 | 5.00 | 0.20 | 5.80 | 848.23 | 169.65 | 336.40 | 264.07 | 0.64 | 0.50 |
| 5.00 | 0.30 | 0.40 | 1.90 | 172.79 | 34.56 | 36.10 | 28.34 | 1.22 | 0.96 |
| 5.00 | 0.50 | 0.40 | 2.10 | 204.20 | 40.84 | 44.10 | 34.62 | 1.18 | 0.93 |
| 5.00 | 1.00 | 0.40 | 2.60 | 282.74 | 56.55 | 67.60 | 53.07 | 1.07 | 0.84 |
| 5.00 | 1.50 | 0.40 | 3.10 | 361.28 | 72.26 | 96.10 | 75.44 | 0.96 | 0.75 |
| 5.00 | 2.00 | 0.40 | 3.60 | 439.82 | 87.96 | 129.60 | 101.74 | 0.86 | 0.68 |
| 5.00 | 3.50 | 0.40 | 4.10 | 518.36 | 103.67 | 168.10 | 131.96 | 0.79 | 0.62 |
| 5.00 | 3.00 | 0.40 | 4.60 | 596.90 | 119.38 | 211.60 | 166.11 | 0.72 | 0.56 |
| 5.00 | 3.50 | 0.40 | 5.10 | 675.44 | 135.09 | 260.10 | 204.18 | 0.66 | 0.52 |
| 5.00 | 4.00 | 0.40 | 5.60 | 753.98 | 150.80 | 313.60 | 246.18 | 0.61 | 0.48 |
| 5.00 | 4.50 | 0.40 | 6.10 | 832.52 | 166.50 | 372.10 | 292.10 | 0.57 | 0.45 |
| 5.00 | 5.00 | 0.40 | 6.60 | 911.06 | 182.21 | 435.60 | 341.95 | 0.53 | 0.42 |

### Example 2

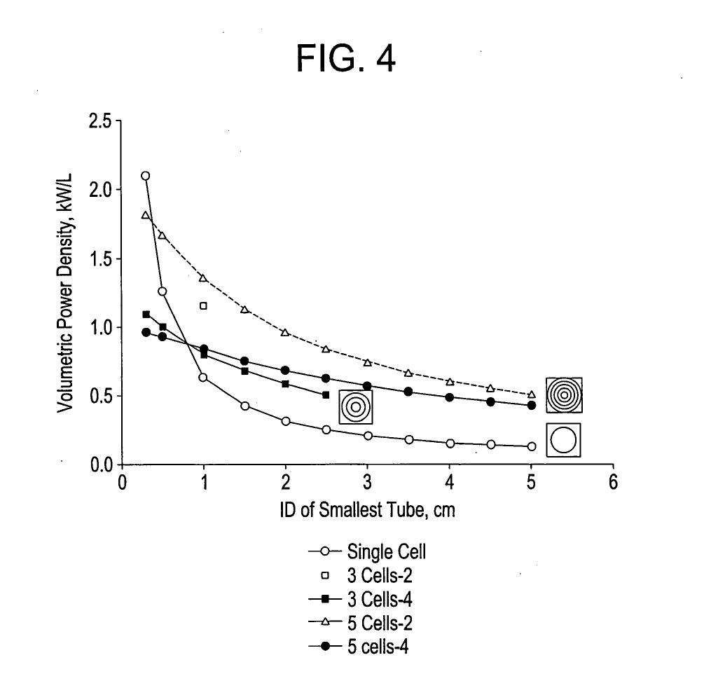

This paper example demonstrates how a high volumetric power packing density may be achieved in a fuel cell stack by stacking electrochemical cells in a manner such that with the exception of the outermost cell, each successive cell is placed within another cell. In this paper example, the volumetric power packing density in kW/L (kilowatt/unit length) generated by two different configurations of electrochemical cell stacks were compared. In one configuration, a single tubular electrochemical cell was used to determine the volumetric power packing density. In the other configuration, an electrochemical cell stack having 3 and 5 concentrically arranged electrochemical cells respectively were used to determine the volumetric power packing density. The volumetric power packing density (Pᵥ) developed in the cells was computed using the equation (I) below:

$${P}_{v} = \frac{4 {P}_{a} n ( {d}_{1} + \frac{n - 1}{2} Δ d )}{{[ {d}_{1} + ( n - 1 ) Δ d ]}^{2}} \qquad ( I )$$

where Pₐ is the average power generated by the electrochemical cell, n represents the number of single electrochemical cells arranged in concentric fashion, d₁ is the inner diameter of smallest tube and Δd is the spacing between successive concentric electrochemical cells. In the FIG. 4, the respective cells in the 3 cell and 5 cell stack are separated by 0.2 and 0.4 centimeters (i.e., Δd is either 0.2 or 0.4 centimeters). The stack wherein the cells are separated by 0.2 centimeters are represented as 3 Cells-2 or 5 Cells-2 respectively, while those wherein the cells are separated by 0.4 centimeters are represented by 3 Cells-4 or 5 Cells-4 respectively.

From FIG. 4 it may be seen that as the inner diameter of the smallest tube is decreased, there is an increase in the volumetric power packing density for both configurations. It may also be seen that for a tube size of about 0.25 centimeters, the volumetric power packing density is approximately 2.1. This is very difficult to achieve in practice, since manufacturing a workable electrochemical cell having a diameter of 0.25 centimeters is difficult. On the other, hand the concentric electrochemical cell having only 5 cells has a volumetric power packing density of 1.8. For inner diameter sizes larger than 1 centimeter, a stack having even 3 concentric electrochemical cells has a larger volumetric power packing density than the comparative single electrochemical cell having an inner diameter less than 1 centimeter. Thus it may be seen that by increasing the number of cells in a stack as detailed above, the volumetric power packing density can be increased while maintaining a manufacturable and usable diameter for the respective electrochemical cells.

From the examples above it may be seen that there are numerous advantages to having the electrochemical cells arranged in a stack with their outer surfaces parallel to each other and wherein with the exception of the outermost tube, the cells are placed within one another. For a stack having 3 cells wherein the smallest cell has a diameter greater than about 1 centimeter, it can that the volumetric power packing density is almost the same as that of a single cell having an inner diameter of less than 0.5 centimeters. In general, for stacks wherein the outermost diameter of the largest electrochemical cell is identical, the fuel utilization is 5% greater, preferably 10% greater, and more preferably 50% greater for a stack wherein the cells are placed within one another when compared with a comparative cell having an equivalent number of cells not placed within one another. In addition as may be seen in the Table 4 below, the volumetric power packing density is about 70% higher, preferably 100% higher, and more preferably 120% higher for a stack wherein the respective electrochemical cells are placed within one another as compared with a cell wherein the respective electrochemical cells are not placed within one another.

TABLE 4

| | Volumetric | Volumetric power | Volumetric power |
|---|---|---|---|
| | power packing | packing density for a | packing density for |
| | density | stack having cells | a stack having cells |
| | increase | located within one | located outside one |
| | over single | another (Pᵥ): | another (Pᵥ): |
| # of | cell config- | d₁ = 10 mm, Δd = 2 mm, | ID = 10 mm, |
| cells | uration | Pₐ = 0.2 W/cm² | Pₐ = 0.2 W/cm² |
| 1 | 0% | 0.80 kW/L | 0.80 kW/L |
| 3 | 84% | 1.47 kW/L | 0.80 kW/L |
| 5 | 116% | 1.73 kW/L | 0.80 kW/L |
| 7 | 131% | 1.85 kW/L | 0.80 kW/L |
| 9 | 140% | 1.92 kW/L | 0.80 kW/L |

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An electrochemical cell stack comprising:
at least two electrochemical cells, wherein each electrochemical cell comprises a hollow elongated electrolyte, having disposed upon it an anode and a cathode, and further wherein with the exception of the outermost cell, each electrochemical cell is placed within another electrochemical cell in a manner such that at least one of the surfaces of the respective electrochemical cells are approximately parallel to one another.

2. The stack of claim 1, wherein successive electrochemical cells are arranged to have either the anodes or the cathodes of a given successive pair of electrochemical cells circumferentially opposed to each other.

3. The stack of claim 1, wherein successive electrochemical cells are arranged in such a manner that for any three successive electrochemical cells there is at least one pair of anodes circumferentially opposed to one another and at least one pair of cathodes circumferentially opposed to one another.

4. The stack of claim 1, wherein the electrochemical cells are attached to each other by spacers.

5. The stack of claim 1, wherein the electrochemical cells are separated by spacers which comprise nickel, nickel alloys, metals coated with the yttria stabilized zirconia or lanthanum strontium gallium magnesium oxides, glass, ceramics, polyimides, polybenzimidazoles, liquid crystalline polymers, ceramics containing glass fibers, metal fibers, glass particles, metal particles, polymeric fibers or combinations comprising at least one of the foregoing.

6. The stack of claim 1, wherein the stack is disposed upon a base plate, and wherein a longitudinal axis of the stack is perpendicular to a surface of the base plate.

7. The stack of claim 6, wherein the base plate comprises nickel, nickel alloys, metals coated with the yttria stabilized zirconia or lanthanum strontium gallium magnesium oxides, glass, ceramics, polyimides, polybenzimidazoles, liquid crystalline polymers, ceramics containing glass fibers, metal fibers, glass particles, metal particles, polymeric fibers or combinations comprising at least one of the foregoing.

8. The stack of claim 7, wherein the base plate comprises grooves into which the electrochemical cells are disposed.

9. The stack of claim 1, wherein at least two successive electrochemical cells are equidistantly spaced from one another.

10. The stack of claim 1, wherein at least two successive electrochemical cells are not equidistantly spaced from one another.

11. The stack of claim 1, wherein the electrochemical cells are concentrically arranged.

12. The stack of claim 1, wherein the electrochemical cells are eccentrically arranged.

13. The stack of claim 1, wherein the respective anodes and cathodes of the electrochemical cells are in electrical communication either in series or parallel with a resistive load.

14. The stack of claim 1, wherein oxygen flows between a pair of cathodes while hydrogen flows between a pair of anodes.

15. The stack of claim 1, wherein the hollow elongated electrolyte, the anode, the cathode or any combination of the foregoing may be used as the supporting structure for the individual electrochemical cells.

16. The stack of claim 1, wherein an edge of an individual electrochemical cell has a triangular, square, rectangular, circular, semi-circular, hexagonal, pentagonal, decagonal shape or combinations comprising at least one of the foregoing shapes.

17. The stack of claim 1, wherein successive electrochemical cells are separated by a distance of about 0.5 millimeter to about 20 millimeters.

18. The stack of claim 1, wherein the hollow elongated electrolyte is formed from yttria stabilized zirconia, lanthanum strontium gallium magnesium oxide, silicon carbide containing phosphoric acid, proton conducting polymer membranes, molten carbonate salt, alkaline electrolytes, or combinations comprising at least one of the foregoing electrolytes.

19. The stack of claim 1, wherein the anode is formed from platinum, ruthenium, iridium, rhodium, palladium, molybdenum, or combinations comprising at least one of the foregoing metals disposed upon carbon paper or carbon fibers.

20. The stack of claim 1, wherein the anode is formed from ceramic powders, wherein the ceramic powders are nickel oxide, cobalt oxide, nickel zirconia, nickel oxide with yttrium stabilized zirconia, nickel oxide with samarium doped ceria, nickel with yttria stabilized zirconia, or combinations comprising at least one of the foregoing ceramic powders.

21. The stack of claim 1, wherein the cathode is formed from ceramic powders, wherein the ceramic powders are lanthanum-samarium-cobalt, samarium-strontium-cobalt, samarium-strontium-cobalt oxide, strontium doped lanthanum manganite, lanthanum manganite, or combinations comprising at least one of the foregoing ceramic powders

22. The stack of claim 1, wherein the cathode is formed from platinum, ruthenium, iridium, rhodium, palladium, molybdenum, or combinations comprising at least one of the foregoing metals disposed upon carbon black.

23. A fuel cell comprising the stack of claim 1.

24. A sensor comprising the stack of claim 1.

25. A oxygen pump comprising the stack of claim 1.
